(19) United States
(12) Patent Application Publication
(10) Pub. No.: US 2006/0029915 A1
(43) Pub. Date: Feb. 9, 2006

(54) Biblical figures

(76) Inventors: Phyllis Adams McCasland, McEwen, TN (US); Shonda Annette McCasland, Fairview, TN (US)

Correspondence Address: Phyllis A. McCasland, 129 Robertson St., McEwen, TN, 37101, US

(21) Appl. No.: 11/177,947

(22) Filed: Jul. 11, 2005

Related U.S. Application Data
(60) Provisional application No. 60/599,236, filed on Aug. 6, 2004.

(51) Int. Cl. G09B 19/00

(52) U.S. Cl. 434/245

(57) ABSTRACT

Biblical figures look life-like in appearance of the Bible era and are unique to the field of Bible study for children in religious matters. Biblical means are made in a one-means designed mold of a plastic, rubber or silicone substance that is firm but somewhat pliable to the touch with Biblical era clothing made as part of the mold in color. Means are small enough to hold in hands of children to enable them to participate in storytelling and are free standing. Other features include, but not limited to, unbreakable, washable, durable, and non-toxic.

### CROSS REFERENCE TO RELATED APPLICATIONS

“This application is benefited by dating of previous filing of Provisional Application” Application No. 60/599/236 by Phyllis McCasland, filed Aug. 6, 2004

### STATEMENT REGARDING FEDERALLY SPONSPORED RESEARCH AND DEVELOPMENT

Non-applicable

### BACKGROUND OF INVENTION

The present invention fills a need that has previously been unfilled as a means of demonstrating Bible stories by hands-on interaction added to hearing for effective teaching. Bible study techniques have not kept pace with our fast computer technology in churches who teach New and Old Testament Bible. The outdated materials used are hand-made teaching tools mostly out of paper products. Flannel graphs are also used. These are paper cut-outs of people, animals, or things with flannel on the back and will stick to a flannel covered board, added as story is being told. Flannel graphs are usually bought to emphasize teachings and are sold at Bible publishing/supply houses. They come with pre-planned Bible material bought by churches quarterly. There are several of these stores in each city. There are 38 businesses in the state of Tennessee as shown in computer search that primary products are religious material and products. Market research show church members number in the millions. Biblical figures are unique in the field and will be sold in these stores and used as a better way of involving students. Being participants during teaching lessons increases interests and memory as is stated in the old Chinese proverb, “tell me, I forget—show me, I remember—involve me, I understand.”

### FIELD OF INVENTION

The present invention relates to Bible Figures of the New and Old Testaments made to engage interactive teaching techniques to children by using hand held figures which will help retain information taught.

### DESCRIPTION OF RELATED ART

Educational Doll: Application No. 872497, Inventors: Richard Ward and John Lemek, U.S. Pat. No. 5,184,958, Issued Feb. 9, 1993, Filed Apr. 23, 1992. Inconsistent Related art is similar to the present invention in that they are both dolls but entirely fulfilling different functions. Related art has a different make-up and is about children adopting dolls by a pre-determined match and does not address the world of Bible teaching.

Educational Doll, Application No. 216891, Inventor: Andrew R. Winslow, U.S. Pat. No. 5,184,958. Filed Dec. 18, 1998, Issued Feb. 9, 1993. These action figures were made to teach about different professions through the change of clothing. These particular action figures have a different make-up and do not address Biblical teaching.

### BRIEF SUMMARY OF INVENTION

One means Biblical Figures made to incorporate student interactively to enhance learning and memory by participation of children during teaching of New and/or Old Testament stories and events. The invention will be used in places of worship or home. Most figures represent more than one person or group of people in any given story and are used individually or grouped together as event requires.

Since modifications vary to fit particular characters, operating requirements and environments will be apparent to those skilled in the art. The invention is not considered limited to the examples chosen for purposes of disclosures, and covers all modifications which do not constitute departures from the true spirit and scope of this invention.

### BRIEF DESCRIPTION OF DRAWINGS

FIG. 1 Front view of Bible woman, disciple of Jesus or any woman of Bible era.

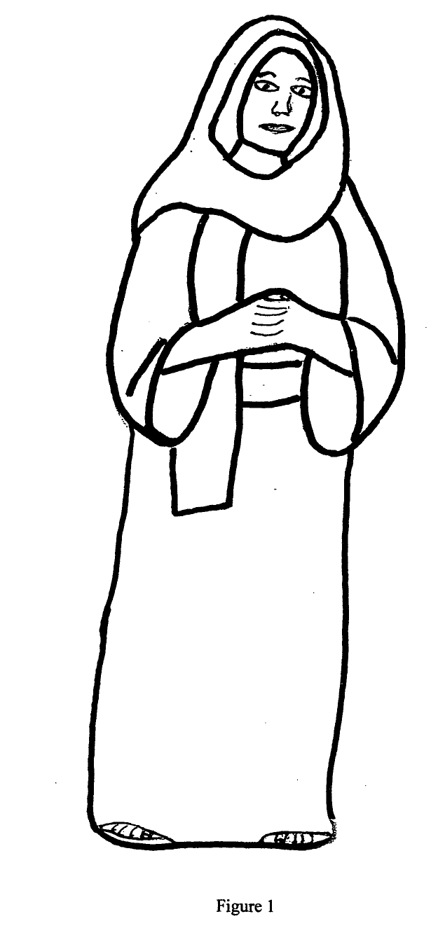

FIG. 2 Front view of child in Biblical dress.

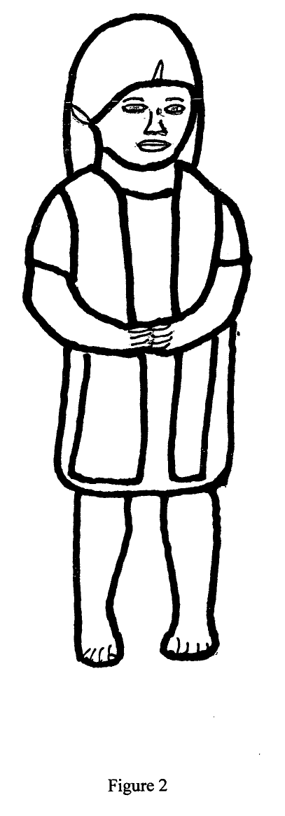

FIG. 3 Abraham or older man wearing tunic and cloak, standard dress for two thousand years of Bible history.

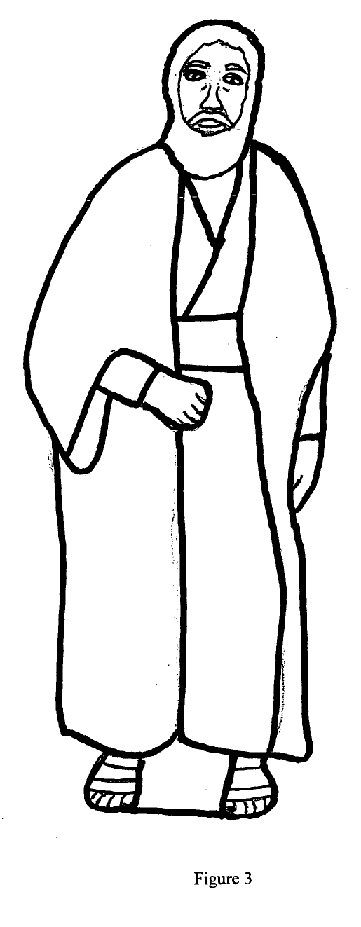

FIG. 4 Bible male apostle wearing headgear of square cloth folded diagonally with fold across forehead with plaited wool to hold it in place over the head and tunic.

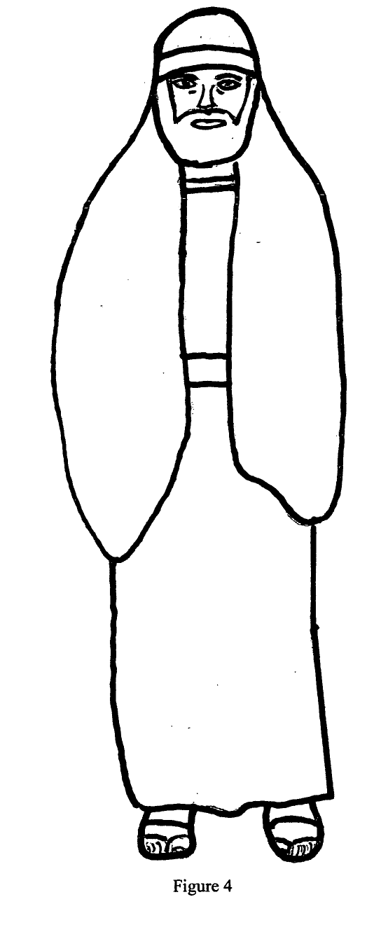

FIG. 5 King in Bible era dress. Generic for other Kings.

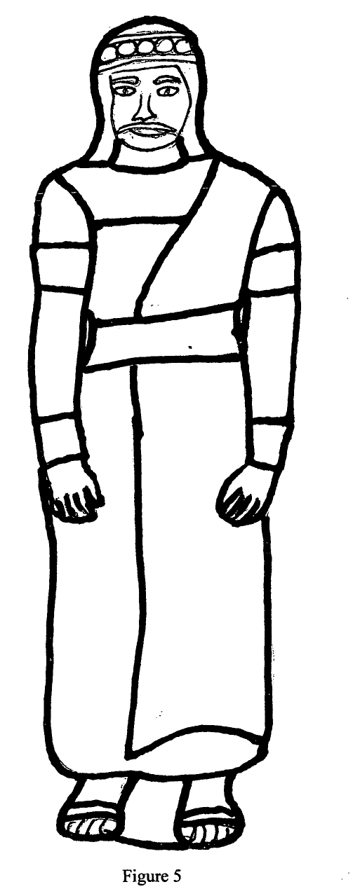

FIG. 6 Young man Jesus or Bible era man wearing tunic and clock.

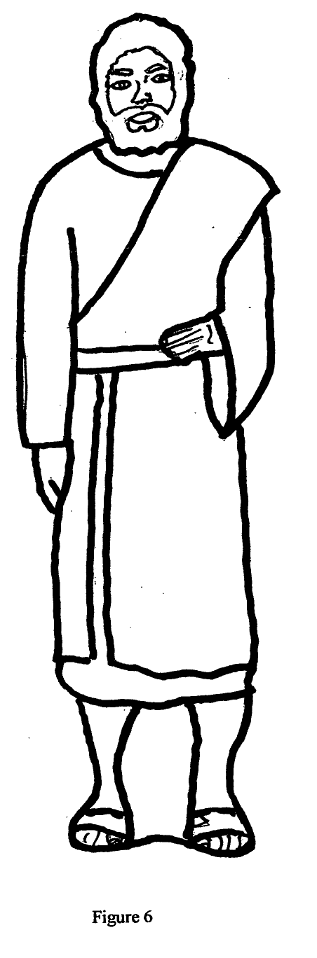

FIG. 7 Roman soldier.

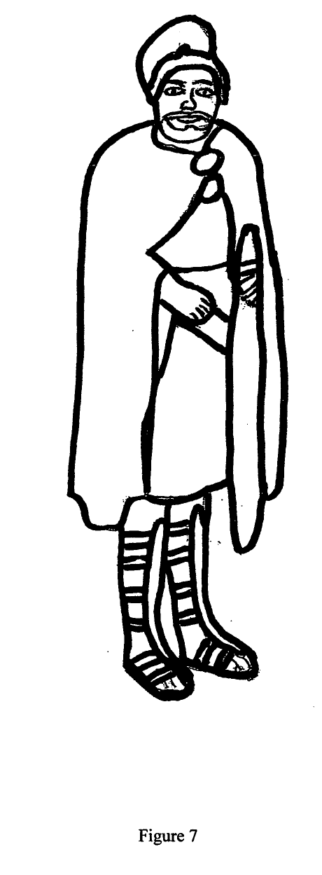

FIG. 8 Egyptian Pharaoh.

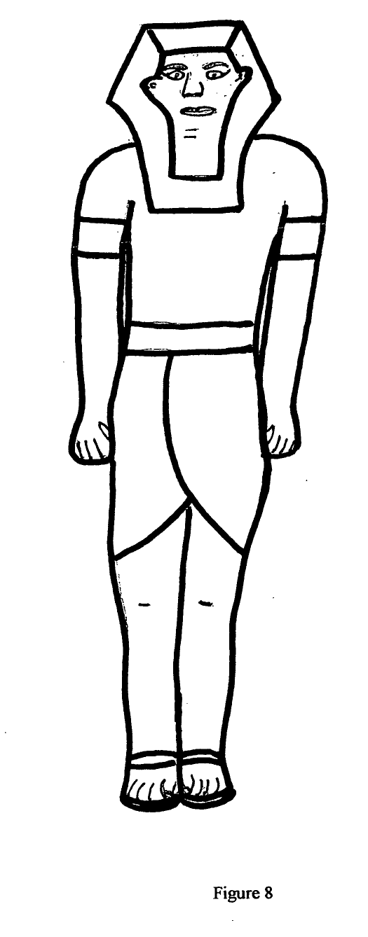

FIG. 9 High Priest wearing an ephod with breastplate inset with twelve colored gemstones symbolizing the twelve tribes of the Hebrew Nation.

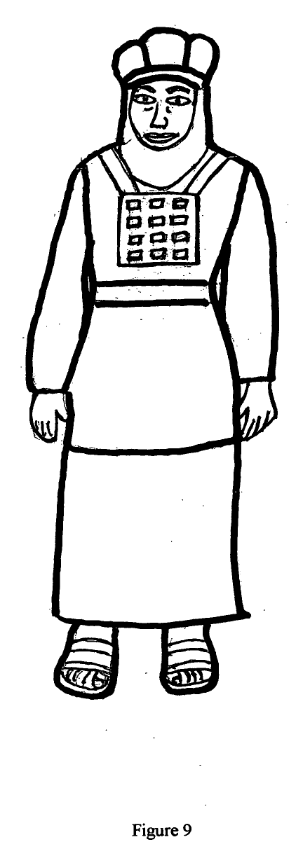

FIG. 10 Shepherd—Generic for New or Old Testament man.

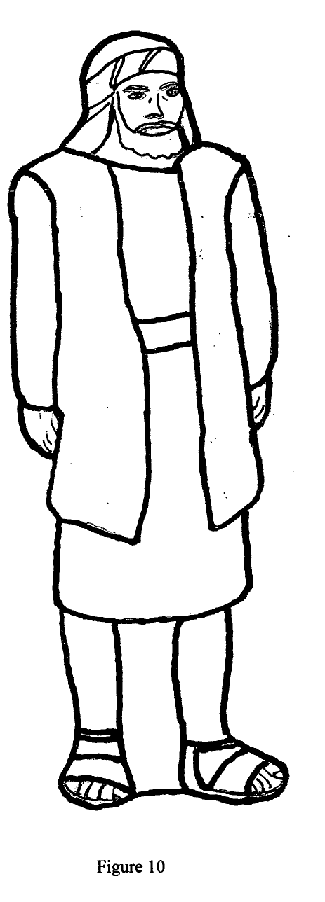

### DETAILED DESCRIPTION OF INVENTION

### Preferred Embodiment

Present invention is made of a single means for each character with one or more used as is needed at a time. Each has a different look as well as different clothing. The physical make-up is to look like real characters from the Biblical era or figures with means made of a rubber-plastic or silicone substance.

Production of Preferred Embodiment

Each figure is made separate by a one piece mold. The substance is poured into a designed mold, once the mold is set it is then removed as a finished product. The clothing is then painted with bright colors.

Operation of Preferred Embodiment

Biblical figures are used for teaching children about the Bible. Means can be moved around by student or teacher handheld during story or event. This teaching tool, by participation and fin, increases learning ability and retention.

I claim:

1. Biblical figures encompass all figures of the New and Old Testament for teaching Bible stories to children of all ages. Changing Bible stories use changing Biblical figures. Biblical figures are new to the field of bible teaching techniques in places of worship or home where bible lessons are taught:
All figures are made as one individual means with no removable parts, are pleasant to the touch, attractive, colorful, life-like, and a good size to hold or move about. Being interactive helps a child remember 90% of what he/she does after three days compared to 10% of what he/she hears after three days. Figures engage and stimulate children for more effective teaching and retention.
Means are different dimensions from top to bottom, including clothes and features, with a base large enough for free-standing capabilities and varying with size of means. Characters are four to ten inches tall according to means being made. The market is open since the Biblical figures are new to the field and will encompass sale areas of churches, Bible supply/publishing houses (that supply churches) toy and department stores.
